(19) United States
(12) Patent Application Publication
(10) Pub. No.: US 2011/0143071 A1
(43) Pub. Date: Jun. 16, 2011

(54) SHEET FOR ABSORBING IMPACT AND SEALING HAVING ADHESIVENESS AND PREPARATION METHOD THEREOF

(75) Inventor: Min-Gi Jung, Suwon-Si (KR)

(73) Assignee: UTIS CO., LTD

(21) Appl. No.: 13/057,014

(22) PCT Filed: Apr. 14, 2009
(86) PCT No.: PCT/KR09/01919

§ 371 Date: Feb. 1, 2011

(30) Foreign Application Priority Data
Aug. 6, 2008 (KR) 10-2008-0076942

(51) Int. Cl. B32B 27/40; B31B 1/72; B41M 3/00; B32B 7/06; C09J 7/02; B65D 81/03

(52) U.S. Cl. 428/41.4; 156/60; 427/147; 428/41.3; 428/41.5

(57) ABSTRACT

The present invention provides an impact-absorbing and sealing sheet having adhesiveness and a preparation method thereof. More specifically, the present invention provides an impact-absorbing and sealing sheet comprising sequentially a release paper, a coating layer on the release paper, a polyurethane layer, and a surface coating layer. The coating layer is formed by coating a side of the release paper with a composition comprising 95 to 99.9 parts by weight of a resin binder which is at least one selected from the group consisting of urethane resin, urethane acryl resin, acryl resin, and acryl silicon resin; and 0.1 to 5 parts by weight of a powder additive which is at least one selected from the group consisting of barium sulfuric acid, calcium carbonate, magnesium carbonate, magnesium hydroxide, talc, and silica. Furthermore, the present invention provides a preparation method of an impact-absorbing and sealing sheet which comprises preparing a release paper; forming a coating layer on the release paper by coating a side of the release paper with a composition; forming a polyurethane layer by coating the coating layer on the release paper with polyurethane; and forming a surface coating layer on the polyurethane layer.

### BACKGROUND OF THE INVENTION

(a) Field of the Invention

The present invention relates to a sheet for absorbing impact and sealing having adhesiveness and preparation method thereof. More specifically, the sheet of the present invention can be applied to the electronic devices, and it prevents components of the electronic devices from being broken by external impact. In addition, it shuts out the influx of pollutants such as dust. Therefore, the sheet of the present invention protects the electronic devices efficiently.

(b) Description of the Related Art

Electronic appliances, such as mobile phones, hard-disk drives, televisions and liquid crystal display, consist of precise machine parts and electro-devices. Those electronic appliances are easily broken down or damaged from external impact. Foreign pollutants, such as dust, cause overheating of electro-devices by disturbing air flow in the electronic appliances. Therefore, this is a factor to shorten the life of electronic appliances. Moreover, harmful electromagnetic waves emitted from electro-devices are one of the biggest factors to lower the performance of adjoining electro-devices, shorten the life of electronic appliances, and increase the rate of inferior goods.

In order to solve these problems, electronic appliances generally have a sheet for sealing to absorb impacts and close up a gap. For example, a silicon pad is attached to an electronic device by placing double-sided adhesive tape on one face of the pad or attaching the pad to the electronic device after coating one face of the pad with an acrylic adhesive. However, there is a problem of exfoliation of the silicon sheet after attaching it to the electronic device, because the silicon material of the pad has low surface tension and poor adhesive strength to adhesive tape or adhesives.

In order to solve these problems, a study for a sheet, which has excellent capacities of sealing, dispersing external impact, preventing malfunction caused by electrification, and good adhesive strength, is required.

FIG. 2 shows an application of a sheet according to the prior art. After a side or both sides of the sheet according to the prior art is laminated with double-sided adhesive tape, the sheet is cut into a request shape and attached to the electronic devices.

However, in case of laminating both sides of the sheet with double-sided adhesive tape, the preparation cost increases, and a capacity of absorbing impact decreases because a thickness of a pad for absorbing impact is reduced as much as a thickness of double-sided adhesive tape. Moreover, in case of laminating only a side of the sheet with double-sided adhesive tape, foreign pollutants can flow in through the other side of the sheet, which is not laminated with the tape, because the gap is not closed up efficiently for external impact and vibration

Therefore, a study for an impact-absorbing and sealing sheet is required. A side of the sheet is required to have adhesiveness so as to laminate only the other side with double-sided adhesive tape at application to the electronic devices. Consequently, the pad for absorbing impact can get thicker than the case of laminating both sides of the sheet with double-sided adhesive tape, so the sheet can shut out the influx of pollutants, such as dust, and protect the electronic devices efficiently.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides an impact-absorbing and sealing sheet having adhesiveness and a preparation method thereof.

To achieve the aspects an embodiment of the present invention provides an impact-absorbing and sealing sheet comprising sequentially a release paper, a coating layer on the release paper, a polyurethane layer, and a surface coating layer. The coating layer is formed by coating a side of the release paper with a composition comprising 95 to 99.9 parts by weight of a resin binder which is at least one selected from the group consisting of urethane resin, urethane acryl resin, acryl resin, and acryl silicon resin; and 0.1 to 5 parts by weight of a powder additive which is at least one selected from the group consisting of barium sulfuric acid, calcium carbonate, magnesium carbonate, magnesium hydroxide, talc, and silica.

Another embodiment of the present invention provides a preparation method of an impact-absorbing and sealing sheet which comprises preparing a release paper; forming a coating layer on the release paper by coating a side of the release paper with a composition that comprises a resin binder of 95 to 99.9 parts by weight, which is at least one selected from the group consisting of urethane resin, urethane acryl resin, acryl resin, and acryl silicon a resin, and a powder additive of 0.1 to 5 parts by weight, which is at least one selected from the group consisting of barium sulfuric acid, calcium carbonate, magnesium carbonate, magnesium hydroxide, talc, and silica; forming a polyurethane layer by coating the coating layer on the release paper with polyurethane; and forming a surface coating layer on the polyurethane layer.

### BRIEF DESCRIPTION OF THE DRAWINGS

FIG. 1 shows a sectional structure of the impact-absorbing and sealing sheet having adhesiveness according to an embodiment of the present invention.

FIG. 2 shows an application of the sheet according to the prior art.

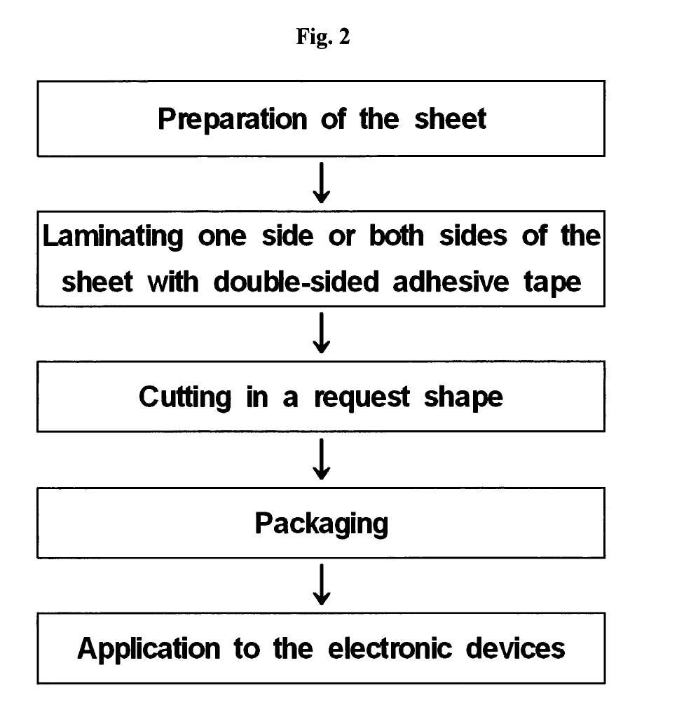

FIG. 3 shows an application of the impact-absorbing and sealing sheet having adhesiveness according to an embodiment of present invention.

### DETAILED DESCRIPTION OF THE EMBODIMENTS

Hereinafter, the impact-absorbing and sealing sheet having adhesiveness according to detailed embodiments of the present invention and the method of preparing the same are explained in more detail. However, they are merely presented as an example of the present invention, and thus it is clearly understood to a person skilled in the art that the scope of the present invention is not limited to the detailed embodiments and various modifications and executions are possible according to the embodiments within the scope of the present invention.

Although it is explained in detail below, the impact-absorbing and sealing sheet having adhesiveness of the present invention has better properties and lower preparation cost than what the prior art has. In addition, it can be applied to an automatic process easily.

Furthermore, the impact-absorbing and sealing sheet having adhesiveness can be applied to the electronic devices, and prevents components of electronic devices from being broken by external impact. In addition, it shuts out the influx of pollutants, such as dust, and protects the electronic devices from electromagnetic waves.

More specifically, in the impact-absorbing and sealing sheet according to the present invention, the surface modification on a side of a polyurethane layer by introducing a coating layer on a release paper can control the peeling strength and adhesiveness between the polyurethane layer and the release paper.

A side of the release paper is coated with a composition that comprises a resin binder of 95 to 99.9 parts by weight, which is at least one selected from the group consisting of urethane resin, urethane acryl resin, acryl resin, and acryl silicon a resin, and a powder additive of 0.1 to 5 parts by weight, which is at least one selected from the group consisting of barium sulfuric acid, calcium carbonate, magnesium carbonate, magnesium hydroxide, talc, and silica. After that, the coating layer on the release paper is foamed with polyurethane. At the same time, a surface of the polyurethane layer contacted to the coating layer is modified, so it has adhesiveness. Moreover, the peeling strength between the polyurethane layer and the release paper is controlled when applying the sheet to the electronic devices.

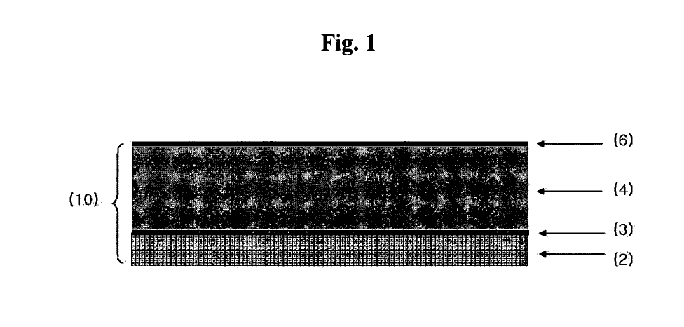

FIG. 1 shows a sectional structure of the impact-absorbing and sealing sheet having adhesiveness to an embodiment of the present invention.

Referring to FIG. 1, the impact-absorbing and sealing sheet having adhesiveness of the present invention 10 comprises sequentially the release paper 2, the polyurethane layer 4, and a surface coating layer 6. The coating layer on the release paper 3 is located between the release paper and the polyurethane layer.

The composition to form the coating layer 3 on the release paper 2 does not have adhesiveness in itself. However, the composition can endow adhesiveness to a surface of the polyurethane layer, after coating the release paper with the composition and forming polyurethane layer on the coating layer 3.

The coating layer 3 of the present invention may be formed by coating a side of the release paper with a composition comprising

a) 95 to 99.9 parts by weight of a resin binder which is at least one selected from the group consisting of urethane resin, urethane acryl resin, acryl resin, and acryl silicon resin; and

b) 0.1 to 5 parts by weight of a powder additive which is at least one selected from the group consisting of barium sulfuric acid, calcium carbonate, magnesium carbonate, magnesium hydroxide, talc, and silica.

The components and proportion of the composition to form the coating layer on the release paper is preferably within the defined range to modify the surface of the polyurethane layer, and to endow adhesiveness to a surface of the polyurethane layer. Moreover, the peel strength between the polyurethane layer and the release paper can be controlled within the range for easy separation of the release paper.

The coating layer 3 on the release paper may be formed with a general method. For example, the coating composition may be dissolved with the solvent, such as methyl ethyl ketone, toluene, dimethyl formamide, cyclohexanone, and so on, to make solution having 20% or less of solid content. After that, the solution may be spread on a polymer film by gravure coater. However, the method of forming the coating layer is not limited thereto.

A thickness of the coating layer on the release paper is not limited, but preferably 0.5 to 2 μm. Within the thickness, a sufficient adhesive strength of the coating layer is obtained so that the polyurethane layer can stay in its own position while assembling the impact-absorbing and sealing sheet. Moreover, the release paper and polyurethane layer may be easily separated from each other at application of the sheet, and a sufficient adhesiveness for application of the polyurethane layer to absorb impact may be obtained. Furthermore, the coating layer on the release paper of the present invention is much thinner than adhesive layer or double-sided adhesive tape layer of the prior art. Thus, the present invention provides a relatively thicker pad for absorbing impact, which comprises polyurethane layer over the entire impact-absorbing and sealing sheet, and thus is very effective for absorbing impact.

According to one embodiment of the present invention, the impact-absorbing and sealing sheet may further comprise an adhesive layer on a side of the surface coating layer, which is not contacted to the polyurethane layer. The adhesive layer may be formed by laminating double-sided adhesive tape on the surface coating layer. Any double-sided adhesive tape, which is usually used in the related field, can be used, and it is not especially limited in the present invention. The thickness of the double-sided adhesive tape is preferably 5 μm to 150 μm considering the whole thickness of the impact-absorbing and sealing sheet.

Moreover, according to one embodiment of the present invention, the impact-absorbing and sealing sheet may further comprise adhesive layer instead of ordinary double-sided adhesive tape. The adhesive layer may be prepared from adhesive materials, which is usually used in the related field, and it is not especially limited in the present invention. The examples of the adhesive materials may be acryl monomer, acryl oligomer, acryl polymer, acetate polymer, and styrene polymer. More preferably, it may be at least one material selected from the group consisting of vinylacetate, methylmethacrylic acid, ethylacetoacrylate, and sulfonated polystyrene. The adhesive layer requires sufficient adhesiveness so that the sheet can attach to the electronic devices. Thus, a peeling strength of the adhesive layer is preferably at least 150 gr/cm so that the polyurethane layer can stay in its own position while assembling or applying the impact-absorbing and sealing sheet. In addition, a thickness of the adhesive layer is preferably 5 to 150 μm considering the thickness of the final product.

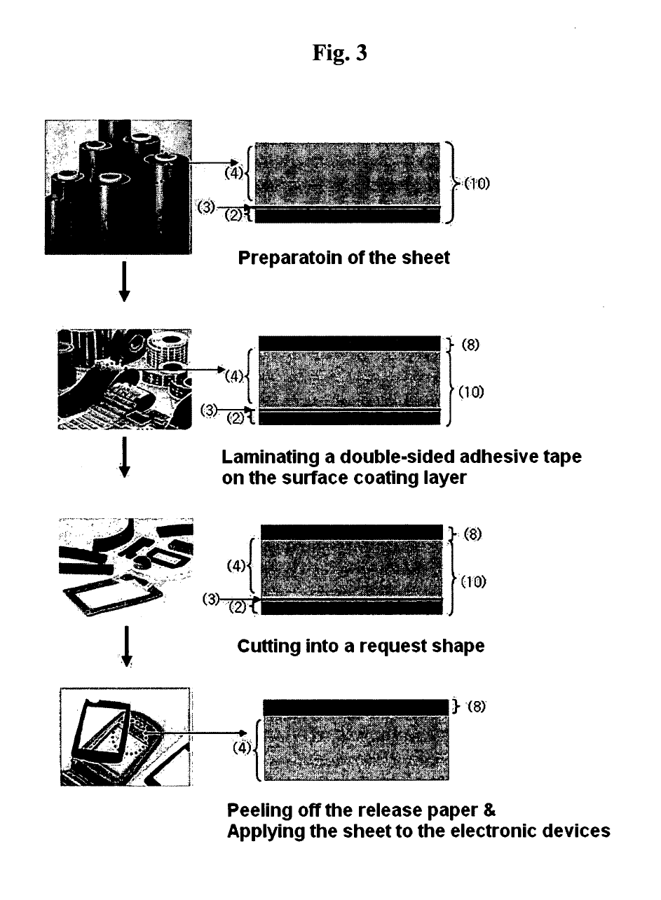

FIG. 3 briefly shows the surface coating layer laminated with double-sided adhesive tape and an application of the present invention comprising the surface coating layer. According to one embodiment of the present invention, the sheet may be cut into a request shape, and attached to the electronic devices after laminating the surface coating layer with double-sided adhesive tape. After that, the release paper is peeled, and the sheet may be applied to the electronic devices.

The release paper 2 of the present invention acts as substrate. The material of the release paper is transparent or white plastic film, but it is not limited thereto. Preferably, the release film may include at least one material selected from the group consisting of polyethyleneterephthalate (PET), polyethylenenaphthalate (PEN) polyesterpolyamide, polycarbonate, ethylene-vinyl acetate copolymer, ethylene-ethyl acrylate copolymer, ethylene-propylene copolymer, and polyvinylchloride. The release paper 2 acts as a supporting film while forming polyurethane foam, after a side of the release paper contacted with the polyurethane layer is coated with the coating layer 3. The coating layer 3 endows adhesiveness to the surface of the polyurethane while curing the polyurethane foam.

Sufficient adhesiveness between the coating layer 3 and polyurethane layer is required so that the polyurethane layer can stay in its own position while assembling the products. Moreover, sufficient peel strength is required to separate the release paper 2 and polyurethane layer easily at application of the sheet.

A peel strength between the release paper and polyurethane layer is preferably 30 to 150 gr/inch so that the sheet 10 can stay in its own position while assembling or applying the products, and the release paper can be easily separated from the polyurethane layer at application. With the same reason above, an adhesive strength of the polyurethane layer is preferably 10 to 100 gr/inch.

The impact-absorbing and sealing sheet of the present invention is attached to the electronic devices, after peeling the release paper.

The polyurethane layer 4 of the present invention acts as a sealing agent to absorb and disperse external impact directly, protect the electronic devices, and prevent the influx of foreign pollutants, when the sheet is applied to interior and exterior of the electronic devices.

Flexible polyurethane, semi-rigid polyurethane, rigid polyurethane, and the others may be used as the material of the polyurethane layer 4, but it is not limited thereto. Preferably, flexible polyurethane may be used. More preferably, the polyurethane layer may be prepared by a reaction between at least one kind of diisocyanate selected from the group consisting of methylenediphenylisocyanate(MDI), toluenediisocyanate(TDI), methylenediphenylisocyanate (MDI) oligomer, toluenediisocyanate (TDI) oligomer, and carbodiimide modified methylenediisocyanate; and at least one polyol mixture selected from the group consisting of polypropyleneglycol, polytetramethyleneglycol, and polyethyleneglycol.

Moreover, a cross-linking agent can be used optionally so as to increase the rate of a cross-linking reaction between pre-polymer and polyol, and to produce cross-liking bond sufficiently. The content may be 0 to 100 parts by weight with respect to 100 parts by weight of pre-polymer.

The cross-linking agent of the present invention may be any agent which is usually used in the polymerization reaction. Preferably, it may be at least one agent selected from the group consisting of trimethylolpropane, triethanolamine, pentaerythritol, tolune diamine, ethylenediamine, glycerine, oxypropylated ethylene diamine, hexamethylene diamine, m-phenylene diamine, diethanolamine, and triethanolamine.

Preferably, a specific gravity of the polyurethane layer 4 may be 0.1 g/cm³ to 0.5 g/cm³ so as to prevent the excessive decrease of mechanical properties and excessive force to the electronic devices at assembling. Moreover, the polyurethane layer may show sufficient performance of impact absorbing within the above range.

The polyurethane layer may preferably have a 25% compressive strength of 0.05 to 0.3 kgf/cm² for the same reason in the specific gravity.

Preferably, a tensile strength of the polyurethane layer 4 may be 2 to 10 kgf/cm² so as to prevent the excessive decrease of mechanical properties and excessive force to the electronic devices while assembling the sheet. Moreover, the polyurethane layer may show sufficient performance of impact absorbing within the above range

A coefficient of extension of the polyurethane is preferably 100 to 300% so as to attach the sheet to the electronic devices closely.

Moreover, a compression set of the polyurethane layer 4 is preferably 10% or less so that the polyurethane layer can have capacities of absorbing impact and sealing in the electronic devices for a long time.

More preferably, the polyurethane layer may have a compression set of 1% to 10%.

A thickness of the polyurethane layer 4 may be changed depending on the electronic devices without limit.

Preferably, the polyurethane layer may have a thickness of 0.1 mm to 2.0 mm.

Within the above range, it can keep the minimum effect of absorbing impact and the sealing effect in uneven surface of the electronic devices. In addition, the electronic devices may become lighter, thinner, shorter, and smaller.

The surface coating layer 6 is formed on a side of the polyurethane layer 4, which is not contacted to the release paper, and located in the outmost of the sheet 10. Moreover, it protects the surface of the sheet and gives sufficient frictional resistance to the surface of the sheet so that the product can be prepared in roll or sheet type.

The material of the surface coating layer 6 may be any coating material, which is usually used in the related field. It may be used without the limit of composition.

Preferably, the surface coating layer may include at least one material selected from the group consisting acryl polymer prepared from acryl-based monomer or oligomer which comprises silicon acrylate, silicon methacrylate, acrylic acid, methacrylic acid, methyl methacrylate and methyl methacrylic acid; urethane-acrylate copolymer or blend; and vinyl polymer comprising polyethylene, polypropylene, polyvinylidenefluoride and TEFLON (tetrafluoroethylne).

The surface coating layer 6 of the present invention may have a peeling strength of 50 gr/inch or more so as to prevent the separation from the polyurethane layer.

A thickness of the surface coating layer 6 may be adjusted depending on the characteristic of the material, and it is preferably 0.5 to 10 μm.

Within the range above, it can prevent cracks while assembling. And, it can prevent the exterior of the sheet 10 from being poor. Moreover, it can keep the coefficient of friction uniformly.

Furthermore, according to another embodiment of the present invention, a method of preparing an impact-absorbing and sealing sheet, which comprises preparing a release paper; forming a coating layer on the release paper by coating a side of the release paper with a composition that comprises a resin binder of 95 to 99.9 parts by weight, which is at least one selected from the group consisting of urethane resin, urethane acryl resin, acryl resin, and acryl silicon a resin, and a powder additive of 0.1 to 5 parts by weight, which is at least one selected from the group consisting of barium sulfuric acid, calcium carbonate, magnesium carbonate, magnesium hydroxide, talc, and silica; forming a polyurethane layer by coating the coating layer on the release paper with polyurethane; and forming a surface coating layer on the polyurethane layer, may be provided.

While forming the polyurethane layer for absorbing impact by coating the coating layer on the release paper with polyurethane, a surface of the polyurethane layer contacted to the coating layer is modified, so the surface has adhesiveness. Moreover, a sufficient peeling strength between the polyurethane layer and the release paper can be obtained.

Various properties of the impact-absorbing and sealing sheet prepared in the above way are the same as stated above.

Furthermore, according to one embodiment of the present invention, the method of preparing an impact-absorbing and sealing sheet, which further comprises laminating a double-sided adhesive tape on the surface coating layer, may be provided.

As stated above, the composition of the double-sided adhesive tape, which is laminated on the surface coating layer, is not limited. Preferably, the double-sided adhesive tape may have a thickness of 5 to 150 μm.

According to the impact-absorbing and sealing sheet of the present invention, a side of the sheet may have adhesiveness so as to laminate only the other side with double-sided adhesive tape or adhesive layer at application to the electronic devices. Consequently, the pad for absorbing impact is relatively thicker than the case of applying double-sided adhesive tape or adhesive layer to the both sides of the sheet. Therefore, the sheet of the present invention has an excellent capacity of absorbing impact, and it can protect the electronic devices from foreign pollutants because the both sides are attached to the electronic devices. Moreover, it can apply to various kinds of electronic devices.

The present invention is further described and illustrated in examples provided below, which are, however, not intended to limit the scope of the present invention.

### Example 1 and 2

### Preparation of the Impact-Absorbing and Sealing Sheet Having Adhesiveness

1) Preparation of the Release Paper Having a Coated Side.

TABLE 1
The components of the composition coated on the release paper

| components | Example 1 | | Example 2 | |
|---|---|---|---|---|
| SGA - 800 (Read chem, | 73.7 | parts by weight | 83.3 | parts by weight |
| acryl silicon) | | | | |
| TTR - duyun (Read | 25.5 | parts by weight | 16.6 | parts by weight |
| chem, acryl urethane) | | | | |
| Syloid C-803 ® | 0.8 | parts by weight | 0.1 | parts by weight |
| (silica, Grace Davison) | | | | |

A polyethyleneterephthalate (skyrol-SH81N, SKC Inc.) SH was coated with the composition of Table 1, and the result was cured. Thus, the release paper coated with the adhesive composition was prepared.

The coating layer on the release paper of Example 1 and Example 2 had a thickness of 1 μm.

2) Forming the Polyurethane Layer

Pre-polymer was prepared in the method that polypropyleneglycol (LUPRANOL L1100, molecular weight 1,100, BASF Inc.) of 100 parts by weight and methylene diphenyl diisocyanate (TCI Inc.) of 600 parts by weight were agitated together at 80° C. of nitrogen atmosphere for 4 hours.

Polyol mixture was prepared in the method that polypropyleneglycol (LUPRANOL L1100, molecular weight 1,100, BASF Inc.) of 220 parts by weight, polypropyleneglycol (LUPRANOL L2030, molecular weight 3,100, BASF Inc.) of 620 parts by weight, 1, 4-butanediol (Acros Inc.) of 90 parts by weight, and dibutyl tin dilaurate (T-12, Air product Inc.) of 0.3 parts by weight were agitated together at 50° C. for 4 hours under reduced pressure.

After the polyol mixture of 100 parts by weight and the pre-polymer of 90 parts by weight were agitated together at 25° C. for 10 seconds, the mixture of them was put on the release paper coated with the adhesive composition prepared in Example 1 and 2. The mixture was cured at 90° C. for 6 hours, and the polyurethane layer having a thickness of 1 mm was formed.

3) Forming the Surface Coating Layer

Subsequently, the mixture of thermoplastic polyurethane (sky thane us705®, SKC Inc.) of 97 wt % and silica (Silisya SY-161, Fuji-Silysia Inc) of 3 wt % was spread on the polyurethane layer. After that, the mixture was cured, and the surface coating layer having a thickness of 2 μm was formed.

### Comparative Example

### Preparation of the Impact-Absorbing and Sealing Sheet Consisting of a Release Paper and a Polyurethane Sheet

Polyurethane foam sheet (SRL, SK Utis) was put on polyethyleneterephthalate (skyrol-SH81N, SKC Inc.), and polyurethane foam having a thickness of 1 mm was prepared.

### Experimental Example

### Measurement of the Properties of Example 1 and 2, and Comparative Example

The properties of the sheets prepared in Examples and Comparative Example above, such as sealing capacity, peeling strength of the release paper, specific gravity, compressive strength, and compression set, was measured after peeling the polyethyleneterephthalate (skyrol-SH81N, SKC Inc.)

### Experimental Example 1

### Sealing Test

Double-sided adhesive tape was attached to one side of a sample (34 (breadth)×54 (length)×3 (width)). The sample was put in a dust test chamber with 25 and 50% of compression, and 400 and 1200 cycle was repeated. It is for showing the influx of the particle.

The size of the particle and the quantity of particle in the chamber is shown below.

* the size of the particle: 30-40 μm.

*the quantity of particle: 2 kg/m³

### Experimental Example 2

### Peeling Strength of the Release Paper

Peeling strength between the polyurethane layer and the release paper was tested at 12 inch/min of speed and with 180° of angle after cutting the sample with a width of 1 inch by Peel test machine (model sp-2000, Imass Inc.).

### Experimental Example 3

### Adhesive Strength of Polyurethane

After cutting the sample with a width of 1 inch by Peel test machine (model sp-2000, (mass Inc.), the polyurethane foam and glass were attached each other with 2 kg of handroller. The adhesive strength of the polyurethane was measured with pulling the polyurethane foam at 12 inch/min. In specific, it is measured by ASTM D3330 method.

### Experimental Example 4

### Specific Gravity

The specific gravity was measured by ASTM D3574.

### Experimental Example 5

### Compressive Strength

The compressive strength of the sample was measured by ASTM D3574 after the sample was put in the condition of 23° C. and 50% of RH for 24 hours.

### Experimental Example 6

### Compression Set

After 50% of compressing at 70° C. for 22 hours, the sample was put in the condition of 23° C. and 50% of RH for 30 minutes. The gap between the initial and final thickness was measured by ASTM D1667.

### Experimental Example 7

### Tensile Strength

After putting the sample (20 mm (width)×130 mm (length)) in the condition of 23° C. and 50% of RH for 24 hours, the tensile strength was measured at a tensile speed of 500 mm/min by Universal Testing Machine by ASTM D 3574.

### Experimental Example 8

### Coefficient of Extension

The coefficient of extension was measured at the point of breaking the sample by ASTM D 3574 after the sample was put in the condition of 23° C. and 50% of RH for 24 hours.

The experimental result of the examples and the comparative example is shown as follows.

TABLE 2
The result of sealing test

| | 400 cycle | | | | | | 1200 cycle | | | | | |
|---|---|---|---|---|---|---|---|---|---|---|---|---|
| | compress | | | | | | | | | | | |
| | 50% | | | 25% | | | 50% | | | 25% | | |
| | the number of times | | | | | | | | | | | |
| | 1 | 2 | 3 | 1 | 2 | 3 | 1 | 2 | 3 | 1 | 2 | 3 |
| Example 1 | X | X | X | X | X | X | X | X | X | X | X | X |
| Example 2 | X | X | X | X | X | X | X | X | X | X | X | X |
| Comparative | X | X | X | X | X | X | X | X | X | X | ◯ | ◯ |
| Example | | | | | | | | | | | | |

(annotation)
◯: the influx of the particle was shown,
X: not shown

TABLE 3
Peeling strength of the release paper
and adhesive strength of poly urethane

| | Example 1 | Example 2 |
|---|---|---|
| Peeling strength | 99.2 g | 68 g |
| Adhesive strength | 54 g | 35 g |

TABLE 4
Specific gravity, compressive strength, compression
set, tensile strength and coefficient of extension

| | | | | | [symbol] |
|---|---|---|---|---|---|
| | [symbol] | 25% | m [symbol] | [symbol] | Coeffi- |
| | Specific | compressive | Compres- | Tensile | cient of |
| | gravity | strength | sion Set | strength | extension |
| | (g/cm³) | (kgf/cm²) | (%) | (kgf/cm²) | (%) |
| Example 1 | 0.16 | 0.11 | <5 | 5.5 | 200 |
| Example 2 | 0.16 | 0.11 | <5 | 5.6 | 200 |
| Comparative | 0.16 | 0.11 | <5 | — | — |
| Example | | | | | |

As shown in examples and comparative example above, the impact-absorbing and sealing sheet having adhesiveness according to the present invention has better properties than what the prior art has. Moreover, a side of polyurethane layer has adhesiveness, so the present invention has an excellent sealing effect.

The sheet of the present invention comprising double-sided adhesive tape on the surface coating layer has a relatively thicker pad for absorbing impact than the prior art laminating double-sided adhesive tape on the both sided of the sheet. Therefore, the sheet of the present invention has an excellent capacity of absorbing impact, and it can protect the electronic devices from foreign pollutants.

What is claimed is:

1. An impact-absorbing and sealing sheet comprising sequentially a release paper, a coating layer on the release paper, a polyurethane layer, and a surface coating layer, and
the coating layer is formed by coating a side of the release paper with a composition comprising 95 to 99.9 parts by weight of a resin binder which is at least one selected from the group consisting of urethane resin, urethane acryl resin, acryl resin, and acryl silicon resin; and 0.1 to 5 parts by weight of a powder additive which is at least one selected from the group consisting of barium sulfuric acid, calcium carbonate, magnesium carbonate, magnesium hydroxide, talc, and silica.

2. The impact-absorbing and sealing sheet of claim 1, wherein the coating layer on the release paper has a thickness of 0.5 to 2 μm.

3. The impact-absorbing and sealing sheet of claim 1, wherein the release film includes at least one material selected from the group consisting of polyethyleneterephthalate (PET), polyethylenenaphthalate (PEN) polyester, polyamide, polycarbonate, ethylene-vinyl acetate copolymer, ethylene-ethyl acrylate copolymer, ethylene-propylene copolymer, and polyvinylchloride.

4. The impact-absorbing and sealing sheet of claim 1, wherein a peeling strength between the polyurethane layer and the release paper is 30 to 150 gr/inch.

5. The impact-absorbing and sealing sheet of claim 1, wherein the polyurethane layer has an adhesive strength of 10 to 100 gr/inch.

6. The impact-absorbing and sealing sheet of claim 1, wherein the polyurethane layer is prepared by a reaction between at least one kind of diisocyanate selected from the group consisting of methylenediphenylisocyanate(MDI), toluenediisocyanate(TDI), methylenediphenylisocyanate (MDI) oligomer, toluenediisocyanate (TDI) oligomer, and carbodiimide modified methylenediisocyanate; and at least one polyol mixture selected from the group consisting of polypropyleneglycol, polytetramethyleneglycol, and polyethyleneglycol.

7. The impact-absorbing and sealing sheet of claim 1, wherein the polyurethane layer has a specific gravity of 0.1 to 0.5 g/cm³.

8. The impact-absorbing and sealing sheet of claim 1, wherein the polyurethane layer has a 25% compressive strength of 0.05 to 0.3 kgf/cm².

9. The impact-absorbing and sealing sheet of claim 1, wherein the polyurethane layer has a tensile strength of 2 to 10 kgf/cm².

10. The impact-absorbing and sealing sheet of claim 1, wherein the polyurethane layer has a coefficient of extension of 100 to 300%.

11. The impact-absorbing and sealing sheet of claim 1, wherein the polyurethane layer has a compression set of 1 to 10%.

12. The impact-absorbing and sealing sheet of claim 1, wherein the polyurethane layer has a thickness of 0.1 to 2.0 mm.

13. The impact-absorbing and sealing sheet of claim 1, wherein the surface coating layer includes at least one material selected from the group consisting of acryl polymer prepared from acryl-based monomer or oligomer which comprises siliconacrylate, siliconmethacrylate, acrylic acid, methacrylic acid, methylmethacrylate and methylmethacrylic acid; urethane-acrylate copolymer or blend; and vinyl polymer comprising polyethylene, polypropylene, polyvinylidenefluoride and TEFLON (tetrafluoroethylne).

14. The impact-absorbing and sealing sheet of claim 1, wherein the surface coating layer has a thickness of 0.5 to 10 μm.

15. The impact-absorbing and sealing sheet of claim 1, further comprising an adhesive layer formed on the surface coating layer.

16. The impact-absorbing and sealing sheet of claim 15, wherein the adhesive layer comprises a double-sided adhesive tape having a thickness of 5 to 150 μm.

17. The impact-absorbing and sealing sheet of claim 15, wherein the adhesive layer is prepared from at least one material selected from the group consisting of vinylacetate, methylmethacrylic acid, ethylacetoacrylate, and sulfonated polystyrene, and has a thickness of 5 μm to 150 μm.

18. A method of preparing an impact-absorbing and sealing sheet according to any one of claims 1 to 10 comprising:
preparing a release paper;
forming a coating layer on the release paper by coating a side of the release paper with a composition that comprises a resin binder of 95 to 99.9 parts by weight, which is at least one selected from the group consisting of urethane resin, urethane acryl resin, acryl resin, and acryl silicon a resin, and a powder additive of 0.1 to 5 parts by weight, which is at least one selected from the group consisting of barium sulfuric acid, calcium carbonate, magnesium carbonate, magnesium hydroxide, talc, and silica;
forming a polyurethane layer by coating the coating layer on the release paper with polyurethane; and
forming a surface coating layer on the polyurethane layer.

19. The method of preparing an impact-absorbing and sealing sheet of claim 18, further comprising:
laminating a double-sided adhesive tape on the surface coating layer.
